(19) United States
(12) Patent Application Publication
(10) Pub. No.: US 2026/0335051 A1
(43) Pub. Date: Oct. 29, 2026

(54) DENTAL ABUTMENT SCREW

(71) Applicant: Jonathan ABENAIM, Hawthorne, NJ (US)

(72) Inventor: Jonathan ABENAIM, Hawthorne, NJ (US)

(21) Appl. No.: 19/295,384

(22) Filed: Aug. 8, 2025

Related U.S. Application Data
(63) Continuation-in-part of application No. 30/000,635, filed on Apr. 23, 2025.

(51) Int. Cl. A61C 8/00

(52) U.S. Cl. CPC A61C 8/0074

(57) ABSTRACT

An abutment screw is used with a screw-receiving abutment for securing a dental prosthesis to a dental implant affixed to a jawbone of a patient. The abutment screw includes a head and a body having a longitudinal axis. The body has a multi-diameter shank with a plurality of sections along the longitudinal axis, including a proximal threaded section having a first diameter, a distal threaded section having a second diameter smaller than the first diameter, and a smooth mid-shank section between the proximal and distal threaded sections, the mid-shank section having a third diameter with is less than the first diameter and may be approximately equal to the second diameter.

### RELATED APPLICATIONS

This application is a continuation-in-part of U.S. Design Patent Application Serial Number 30/000,635, titled “Dental Abutment Screw”, filed Apr. 23, 2025, which is incorporated herein by reference.

### BACKGROUND

Dental implants and abutments are key components in the field of restorative dentistry. A dental implant is a post, usually made of titanium, that is surgically placed into the jawbone, acting as a replacement for the root of a missing tooth. This implant provides a sturdy foundation for the attachment of artificial teeth.

While the implant functions as an artificial root, the abutment is a connecting element that holds the artificial tooth, crown or bridge in place. This two-part system mimics the natural structure of a tooth. They are typically made from durable materials like titanium or zirconia, ensuring a stable and secure fit. The abutment is designed to support the prosthetic tooth, providing a natural appearance and functional bite.

Over time, the durability and effectiveness of dental implants and abutments can significantly impact oral function and comfort. Both components are designed to withstand the forces of chewing and biting.

### SUMMARY

In a first aspect, an abutment screw is used with a screw-receiving abutment for securing a dental prosthesis to a dental implant affixed to a jawbone of a patient. The abutment screw has a longitudinal axis and includes a head and a body having a multi-diameter shank along the longitudinal axis. The body includes a proximal threaded section having a first diameter D₁, a distal threaded section having a second diameter D₂, where D₂<D₁, and a smooth mid-shank section between the proximal and distal threaded sections, the mid-shank section having a third diameter D₃, where D₃<D₁. In addition, D3≅D₂.

Further, the body includes a proximal shaft section between the head and the proximal threaded section. The diameter of the proximal shaft section may be approximately equal to D₁.

Still further, the head includes an upper surface, having a drive centered on the longitudinal axis and a curved edge, and an underside surface having a convex radiused curvature extending until it meets the body, the convex radiused curvature being configured to conform to a corresponding concave curvature of a receiving portion of the dental prosthesis.

In another aspect, a dental prosthesis may be used with the abutment screw, the dental prosthesis having a through hole with female threading sized to engage with the proximal threaded section of the abutment screw.

In another aspect, a tooth replacement assembly includes the abutment screw, a screw-receiving abutment having a first end configured to securely engage with a dental implant affixed to a jawbone of a patient and having a second end with a female threaded bore hole sized to engage with the distal threaded section of the abutment screw, and a dental prosthesis having a channel, a portion of which is a female threaded section sized to engage with the proximal threaded section of the abutment screw.

Further, the head of the abutment screw comprising an underside surface having a convex radiused curvature extending until it meets the body.

In addition, the dental prosthesis has a receiving surface surrounding the channel, the receiving surface having a concave curvature configured to conform to the convex radiused curvature of the underside surface of the head of the abutment screw.

### BRIEF DESCRIPTION OF THE FIGURES

FIG. 1 is a side view of a dental abutment screw, in embodiments.

FIG. 2 is a cross-sectional view of the dental abutment screw of FIG. 1, taken along the line 2-2.

FIG. 3 is a side view of a dental abutment screw, showing representative dimensions, in embodiments.

FIG. 4 is a cross-sectional view of the dental abutment screw of FIG. 3, taken along the line 4-4.

FIG. 5 is an end view of the dental abutment screw of FIG. 3, in embodiments.

FIG. 6 is a detailed view of FIG. 5, in embodiments.

FIG. 7 is a schematic side view of a tooth assembly using the dental abutment screw of FIG. 1, in embodiments.

### DETAILED DESCRIPTION OF THE EMBODIMENTS

Abutments have a vital role in dental restoration. They are attached to an implant that has been placed in a patient's jawbone to provide a foundation for attaching a dental prosthesis, crown, bridge or other device that replaces the patient's teeth. Abutments may be attached to the implant in a variety of ways. The abutment itself may be threaded into the implant, or it may be attached using screws or cement.

A dental prosthesis is typically attached to an abutment using screws or cement. Abutments used with cement are different from those used with screws and are typically used in different situations, such as in front row teeth. A screw-receiving abutment is used with screw-retained prosthesis that includes a through hole for receiving a screw that is threaded into a female threading in the abutment. Attaching a prosthesis to an abutment using screws facilitates maintenance because the prosthesis may be replaced and repaired without causing damage to surrounding components. Unfortunately, the screw may loosen over time and require tightening during a visit to a dentist.

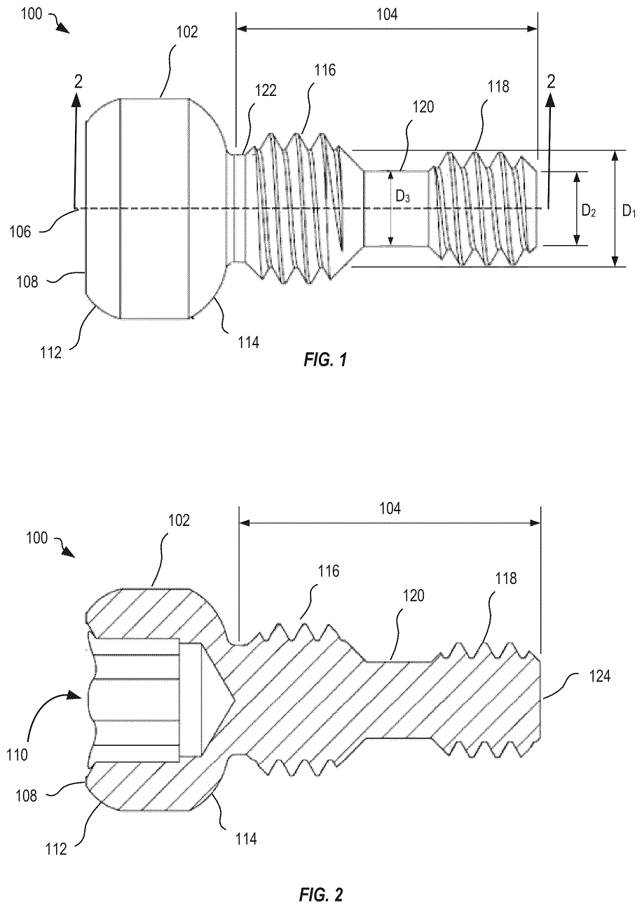

FIG. 1 depicts a side view of a dental abutment screw 100 with engagement with a dental prosthesis. FIG. 2 is a cross sectional view along the line 2-2 in FIG. 1. FIGS. 1 and 2 are best viewed together in the following description.

Abutment screw 100 includes a head 102 and a body 104 having a longitudinal axis 106. Head 102 is cylindrical with an upper surface 108 having a drive 110 centered on longitudinal axis 106 and a curved edge 112. Head 102 also includes an underside surface 114 having a convex radiused curvature extending until it meets the shank, the convex radiused curvature being configured to conform to a corresponding concave curvature of a receiving portion of the dental prosthesis. In embodiments, the radius of curvature of curved edge 112 is the same as that of underside surface 114.

Body 104 has a multi-diameter shank, the shank having a plurality of diameters along longitudinal axis 106. Body 104 includes a proximal threaded section 116 having a minor (or first) diameter D₁. A distal threaded section 118 has a minor (or second) diameter D₂, where D₂<D₁. Proximal threaded section 116 and distal threaded section 118 are separated by a smooth mid-shank section 120 that is absent of threading. Mid-shank section 120 has a diameter D₃, where D₃<D₁. In embodiments, D₃ is equal to or approximately equal to D₂. As shown in FIGS. 1 and 2, distal end 124 of body 104 is shown as being flat and engages with an abutment, although other configurations of distal end 124 may be used such as pointed or curved.

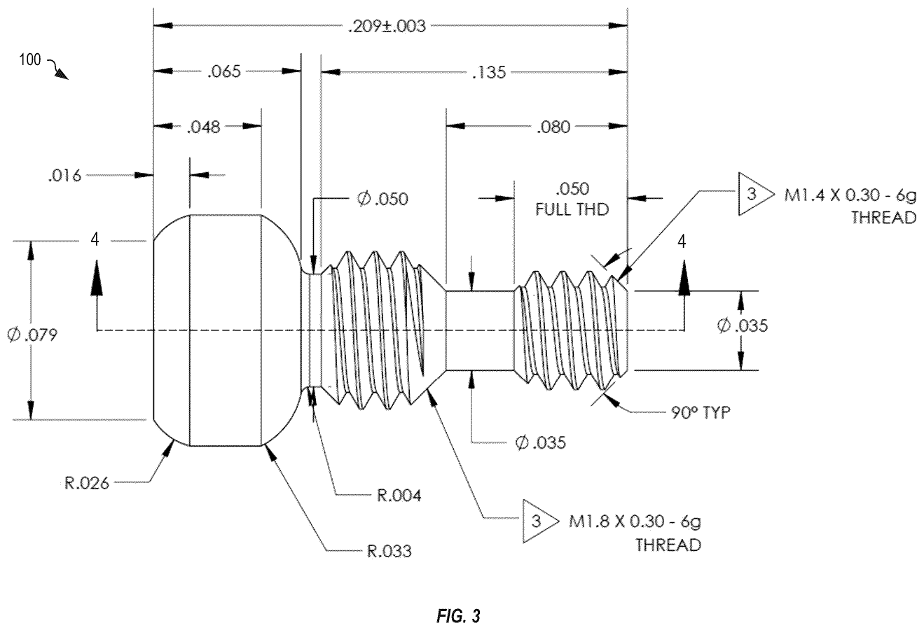

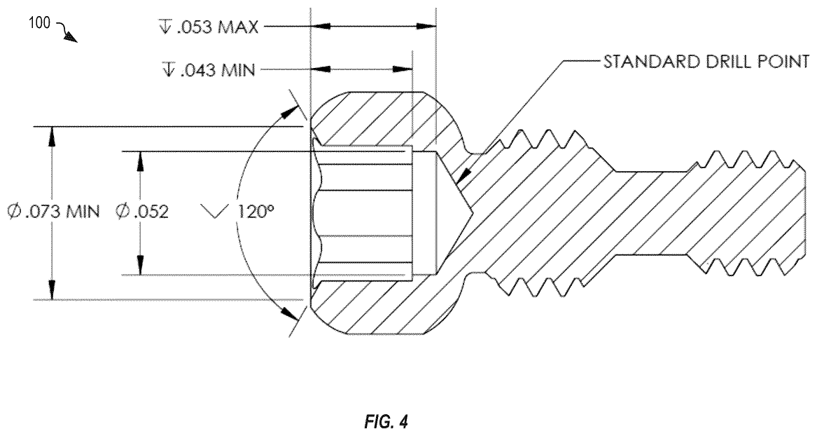

In embodiments, body 104 includes a proximal shaft section 122 between underside surface 114 of head 102 and proximal threaded section 116. Additional surfaces with convex radii of curvature as shown in FIG. 3 may be included between head 102 and proximal shaft section 122 to provide improved strength, function or manufacturability. Although not shown in the figures, some embodiments may include additional curved or slanted surfaces at transitions between any of the threaded and non-threaded sections of body 104.

FIGS. 3 and 4 correspond to FIGS. 1 and 2 and show various dimensions. These dimensions are shown only for the purpose of illustration. Embodiments encompassed within this disclosure are not limited to the dimensions shown in the figures. Any of the lengths, diameters, radii, thread pitches, etc., may be changed from those shown as long as the overall size of the screw is suitable for use in securing a dental prosthesis to a screw-receiving abutment in a patient's mouth.

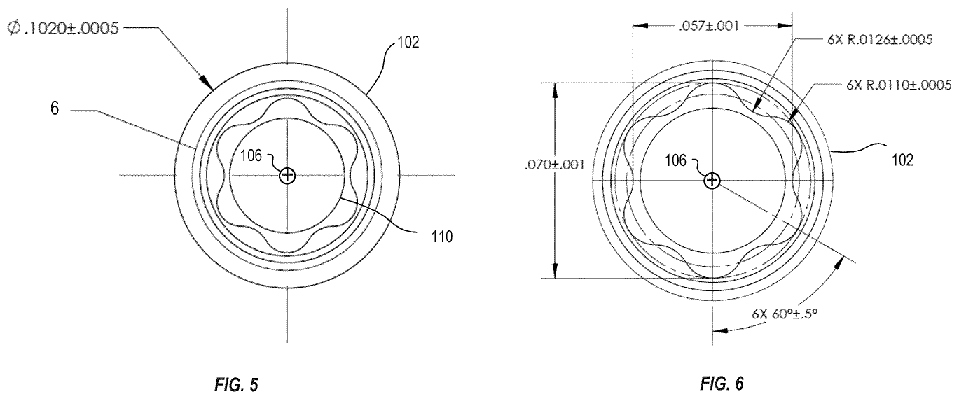

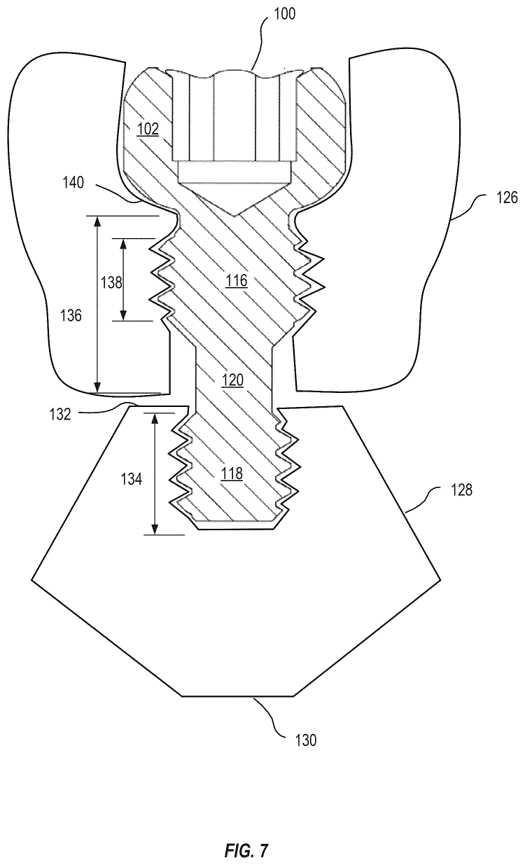

FIG. 5 is an end view of the dental abutment screw of FIG. 3 and FIG. 6 is a detailed view of FIG. 5. Drive 110 as illustrated is a particular type of hex drive, which is an excellent shape for driving an abutment screw. However, embodiments discussed herein are in no way limited to the use of the illustrated type of hex drive, and any other appropriate drive can be used in abutment screw 100. In addition, dimensions shown in the figures are for purposes of illustration only.

FIG. 7 is a schematic side view of a tooth assembly using the dental abutment screw of FIG. 1. Abutment screw 100 is shown securing a dental prosthesis 126 to abutment 128. The schematic representations of prosthesis 126 and abutment 128 are to illustrate principles of abutment screw 100 as disclosed herein and are not limiting. One of ordinary skill in the art would recognize that prosthesis 126 represents any device that may be used in dental restorations. Likewise, abutment 128 may have a different profile and may include other features and components not illustrated in FIG. 7.

Abutment 128 includes a first end 130 which may be generally configured in a variety of ways to securely engage with a dental implant affixed to a jawbone of a patient. Second end 132 includes with a female threaded bore hole 134 sized to engage with distal threaded section 118 of abutment screw 100. The threads of bore hole 134 have a pitch and diameter that will enable secure retention of abutment screw 100 in abutment 128.

Dental prostheses 126 includes a channel 136 through which abutment screw 100 passes before engaging with abutment 128. A female threaded section 138 of channel 136 is sized to threadingly engage with proximal threaded section 116 of abutment screw 100. The threads of female threaded section 138 have a pitch and diameter that will enable retention of abutment screw 100 in prosthesis 126.

As disclosed herein, proximal threaded section 116 and female threaded section 138 may be understood as a secondary thread so that abutment screw 100 is threaded through dental prosthesis 126 and then screws into the abutment 128. Instead of being held only by a clamping force between underside surface 114 of head 102 and a corresponding receiving surface 140 of prosthesis 126, it is also held in by the threaded section. When abutment screw 100 is fully engaged, the threading engagement results in a tight fit between abutment screw 100, dental prosthesis 126, and the abutment 128.

Because the diameter of distal threaded section 118 is smaller than the diameter of proximal threaded section 116, distal threaded section 118 and mid-shank section 120 pass through channel 136 of prosthesis 126 without engaging threaded section 138. Also, the change in diameter between proximal threaded section 116 and mid-shank section 120 creates a relatively weak interface or “break point” at or near the connection between sections 116 and 120. Thus, in the event the screw, by way of extended use over time, for example, will break, the break will occur at the break point. This facilitates removal of the broken portions 120 and 118 from a patient's jaw by allowing a dental practitioner access to the smooth mid-shank section for replacement with another screw. When installing abutment screw 100, the dimension of threaded section 138 ensures that abutment screw 100 will only engage prosthesis 126 at threading 138 while distal threaded section 118 finds engagement with female threaded bore hole 134 of abutment 128.

While embodiments have been discussed in the context of prostheses for individual teeth, the are also applicable to partial dentures, crowns, bridges or any hybrid denture prosthesis.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An abutment screw for use with a screw-receiving abutment for securing a dental
prosthesis to a dental implant affixed to a jawbone of a patient, the abutment screw having a longitudinal axis and comprising:
a head; and
a body having a multi-diameter shank along the longitudinal axis, the body comprising:
a proximal threaded section having a first diameter D₁;
a distal threaded section having a second diameter D₂, where D₂<D₁; and
a smooth mid-shank section between the proximal and distal threaded sections, the mid-shank section having a third diameter D₃, where D₃<D₁.

2. The abutment screw of claim 1, wherein D₃≅D₂.

3. The abutment screw of claim 1, wherein the body further comprises a proximal shaft section between the head and the proximal threaded section.

4. The abutment screw of claim 3, wherein the diameter of the proximal shaft section is approximately equal to D₁.

5. The abutment screw of claim 1, the head comprising:
an upper surface, having a drive centered on the longitudinal axis and a curved edge; and
an underside surface having a convex radiused curvature extending until it meets the body, the convex radiused curvature being configured to conform to a corresponding concave curvature of a receiving portion of the dental prosthesis.

6. A dental prosthesis for use with the abutment screw of claim 1, the dental prosthesis having a through hole with female threading sized to engage with the proximal threaded section of the abutment screw.

7. A tooth replacement assembly, comprising:
an abutment screw having a longitudinal axis and comprising:
a head; and
a body having a multi-diameter shank along the longitudinal axis, the body comprising:
a proximal threaded section having a first diameter D₁;
a distal threaded section having a second diameter D₂, where D₂<D₁; and
a smooth mid-shank section between the proximal and distal threaded sections, the mid-shank section having a third diameter D₃, where D₃<D₁.
a screw-receiving abutment having a first end configured to securely engage with a dental implant affixed to a jawbone of a patient and having a second end with a female threaded bore hole sized to engage with the distal threaded section of the abutment screw; and
a dental prosthesis having a channel, a portion of which is a female threaded section sized to engage with the proximal threaded section of the abutment screw.

8. The tooth replacement assembly of claim 7, the head of the abutment screw comprising an underside surface having a convex radiused curvature extending until it meets the body.

9. The tooth replacement assembly of claim 8, the dental prosthesis having a receiving surface surrounding the channel, the receiving surface having a concave curvature configured to conform to the convex radiused curvature of the underside surface of the head of the abutment screw.
